(19) United States
(12) Patent Application Publication
(10) Pub. No.: US 2019/0190330 A1
(43) Pub. Date: Jun. 20, 2019

(54) STACKED CORE, DEVICE FOR MANUFACTURING STACKED CORE, AND METHOD OF MANUFACTURING STACKED CORE

(71) Applicant: Mitsui High-tec, Inc., Kitakyushu-shi (JP)

(72) Inventor: Kiminori Shudo, Kitakyushu-shi (JP)

(73) Assignee: Mitsui High-tec, Inc., Kitakyushu-shi (JP)

(21) Appl. No.: 16/213,818

(22) Filed: Dec. 7, 2018

(30) Foreign Application Priority Data
Dec. 15, 2017 (JP) 2017-240979

(51) Int. Cl. H02K 1/27; H02K 1/28; H02K 15/03; H02K 15/02

(52) U.S. Cl. CPC H02K 1/276; H02K 15/024; H02K 15/03; H02K 1/28

(57) ABSTRACT

A stack formed by stacking a plurality of blanked members includes a first blanked member forming an outermost layer of the stack and a second blanked member located adjacent to the first blanked member. A through is hole formed in the first blanked member, and an area of the through hole has a length that is greater than a width. A connecting tab having a chevron shape is formed in the second blanked member so as to be fitted into the through hole of the first blanked member. On opposite sides of the through hole, notches are recessed outward from an inner-wall surface of the through hole in opposing directions that correspond to the width of the area of the through hole.

### CROSS-REFERENCE TO RELATED APPLICATIONS

This application claims the benefit of priority from Japanese Patent Application No. 2017-240979, filed on Dec. 15, 2017, the entire contents of which are incorporated herein by reference.

### FIELD

The present disclosure relates to a stacked core, a device for manufacturing the stacked core, and a method of manufacturing the stacked core.

### BACKGROUND

Japanese Unexamined Patent Publication No. 2007-014122 discloses a method of manufacturing a stacked core including a first step of forming a through hole or a connector at a predetermined position of a belt-like metal sheet (workpiece sheet) wound in a coiled shape while sequentially feeding a coiled material of the metal sheet at a predetermined pitch from an uncoiler on an intermittent basis. Additionally, the method includes a second step of blanking the metal sheet with a punch to form a blanked member having the through hole or the connector, and a third step of stacking and fastening together a plurality of blanked members by a through hole and connectors to form the stacked core.

The connector has a groove formed in the corresponding blanked member on its upper-surface side and a protrusion formed on the blanked member on its lower-surface side. The protrusion of the connector of one blanked member is fitted into the groove of the connector of another blanked member. Additionally, the protrusion of a connector of a blanked member adjacent to the lowermost layer of the stacked core is fitted into the though hole. When a plurality of stacks are successively manufactured, the through hole has the function of preventing a subsequently manufactured stack from being fastened by the connector to an already manufactured stack.

### SUMMARY

A stack formed by stacking a plurality of blanked members includes a first blanked member forming an outermost layer of the stack and a second blanked member located adjacent to the first blanked member. A through is hole formed in the first blanked member, and an area of the through hole has a length that is greater than a width. A connecting tab having a chevron shape is formed in the second blanked member so as to be fitted into the through hole of the first blanked member. On opposite sides of the through hole, notches are recessed outward from an inner-wall surface of the through hole in opposing directions that correspond to the width of the area of the through hole.

### BRIEF DESCRIPTION OF THE DRAWINGS

FIG. 1 is a perspective view illustrating an example stacked rotor core;

FIG. 2 is a sectional view taken along line in FIG. 1;

FIG. 3 is an exploded perspective view illustrating a state in which a connecting tab is fitted into a through hole of a blanked member

FIG. 4 is a schematic diagram illustrating an example device for manufacturing a stacked rotor core;

FIG. 5A is a perspective view illustrating an example punch configured to form a through hole;

FIG. 5B is a perspective view illustrating an example die hole corresponding to the punch of FIG. 5A;

FIG. 6A is a perspective view illustrating an example punch configured to form a connecting tab;

FIG. 6B is a perspective view illustrating an example die hole corresponding to the punch of FIG. 6A;

FIG. 7A is a schematic sectional view illustrating an example process of forming a through hole:

FIG. 7B is a schematic sectional view illustrating an example process of forming a connecting tab;

FIG. 8 is a sectional view schematically illustrating a mechanism to stack blanked members and a mechanism to discharge a stack from a die, as a diagram for explaining a process of blanking, with a punch, a blanked member from an electrical steel sheet;

FIG. 9 is an enlarged sectional view illustrating an example pressing protrusion of the punch of FIG. 8;

FIG. 10 is a sectional view schematically illustrating an example mechanism to stack blanked members and an example mechanism to discharge a stack from a die; and

FIG. 11 is an enlarged sectional view illustrating part of an example stacked core having a burr.

### DETAILED DESCRIPTION

In the following description, with reference to the drawings, the same reference numbers are assigned to the same components or to similar components having the same function, and overlapping description is omitted.

### Stacked Rotor Core

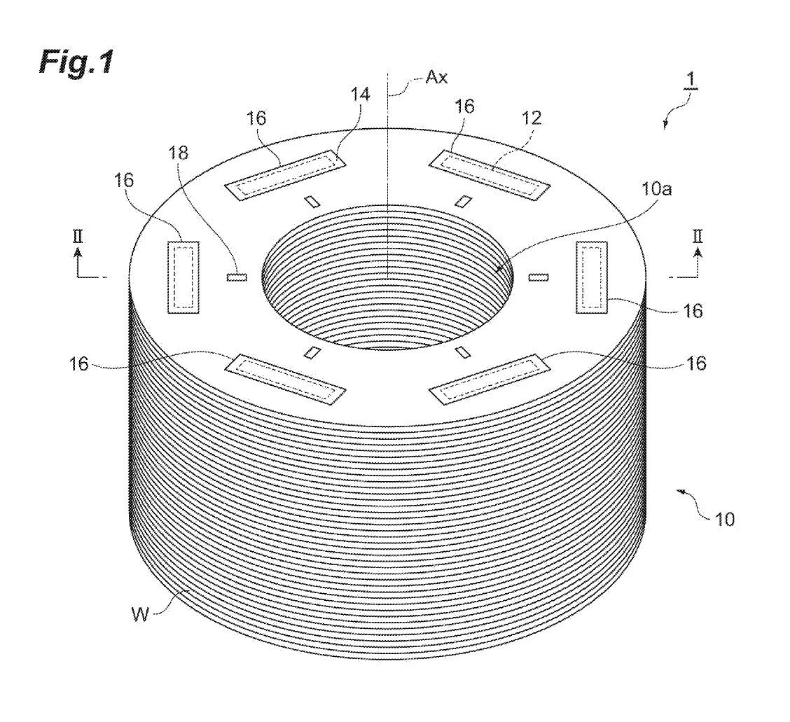

FIG. 1 to FIG. 3 illustrates an example configuration of a stacked rotor core 1 (stacked core). The stacked rotor core 1 is part of a rotor. The rotor may be formed by attaching end lace plates and a shaft to the stacked rotor core 1. By assembling the rotor with a stator, a motor is formed.

As depicted in FIG. 1, the stacked rotor core 1 includes a stack 10, a plurality of permanent magnets 12, and a plurality of solidified resins 14.

The stack 10 has a cylindrical shape as depicted in FIG. 1. A shaft hole 10a penetrating the stack 10 in a height direction of the stack 10 (hereinafter, simply called “height direction”) is formed in a central portion of the stack 10. In some examples, the shaft hole 10a extends along a central axis Ax of the stack 10. The stack 10 is rotated about the central axis Ax, and thus the central axis Ax is also a rotation axis. A shaft may be inserted into the shaft hole 10a.

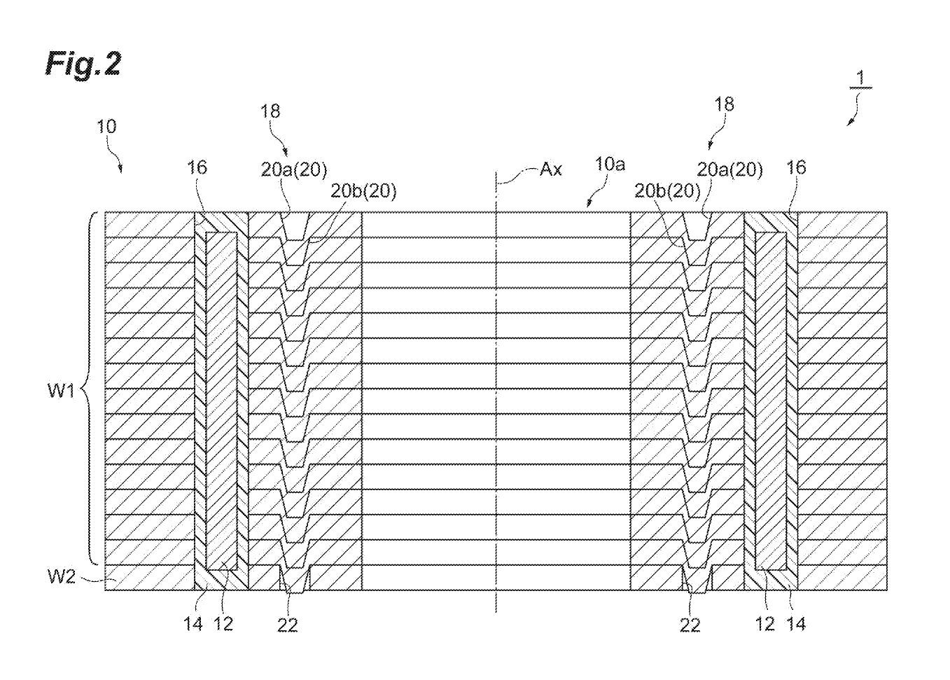

A plurality of magnet insertion holes 16 are formed in the stack 10. As depicted in FIG. 1, the magnet insertion holes 16 are aligned along the outer periphery of the stack 10 at predetermined intervals. As depicted in FIG. 2, the magnet insertion holes 16 penetrate the stack 10 so as to extend along the central axis Ax. In some examples, the magnet insertion holes 16 extend in the height direction.

Each magnet insertion hole 16 has the shape of an oblong hole extending along the outer periphery of the stack 10. The number of the magnet insertion holes 16 may be six in some examples. The positions, the shapes, and the number of the magnet insertion holes 16 may be changed based on intended use and/or to selectively vary the performance, for example, of the motor.

The stack 10 is formed by stacking a plurality of blanked members W Each blanked member W is a plate-like member obtained by blanking an electrical steel sheet ES (described in further detail later) in a predetermined shape, and has a shape corresponding to the shape of the stack 10. In some examples, a blanked member located at the lowermost layer of the blanked members W forming the stack 10 may be referred to as “blanked member W2” or “first blanked member”, and the blanked members located at layers other than the lowermost layer of the blanked members W forming the stack 10 may be referred to as “blanked member(s) W1” or “second blanked member(s)”.

The stack 10 may be formed by what is called a rotational stack. The term “rotational stack” may be understood to refer to stacking a plurality of blanked members W while relatively shifting the angle between the blanked members W. The rotational stack may be performed to compensate for variations in thickness of the stack 10. The angle of rotational stack may be set at any angle.

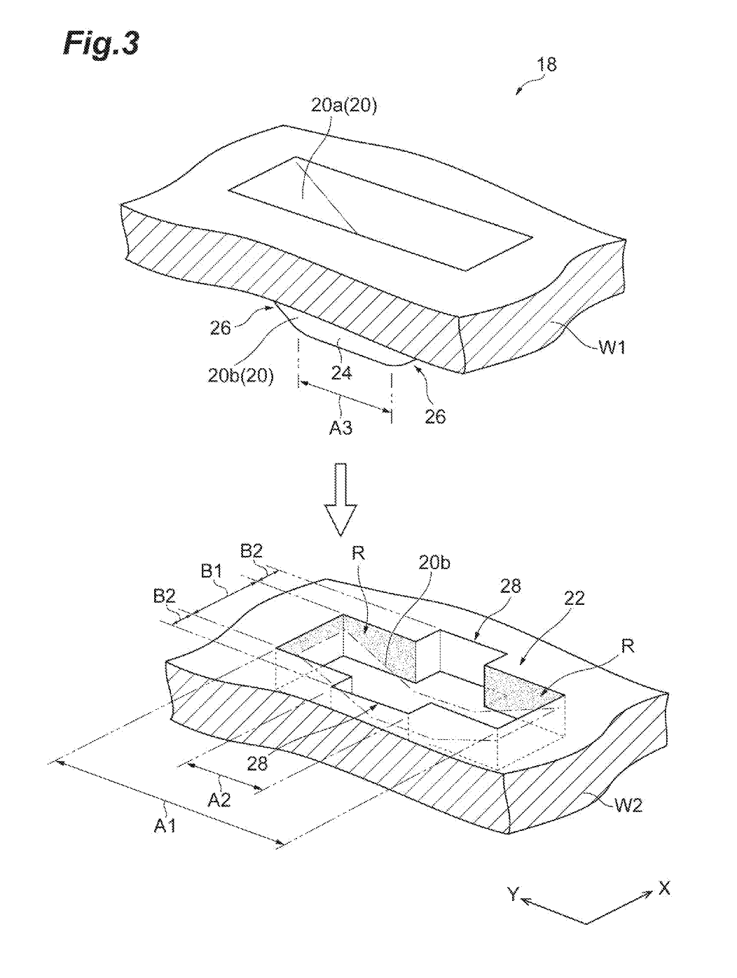

Blanked members W adjacent to each other in the height direction are fastened together by interlocking parts 18 as depicted in FIG. 1 to FIG. 3. For example, each interlocking part 18 includes tabs (connecting tabs) 20 formed in the blanked member W1 and a through hole 22 formed in the blanked member W2 as depicted in FIG. 2 and FIG. 3.

Each connecting tab 20 has a depression 20a formed in a blanked member W1 on its upper-surface side and a projection 20b formed on the blanked member W1 on its lower-surface side. When viewed from the X-axis direction in FIG. 3, each connecting tab 20 as a whole has a chevron shape. For example, the swaged area of the connecting tab 20 has a tip 24 where the protruding height of the projection 20b is greatest and shoulders 26 that are located on both sides of the tip 24 in the Y-axis direction, as shown in FIG. 3. In some examples, the tip 24 has a flat shape. The protruding height of each shoulder 26 gradually decreases from the tip 24 to the outside in the Y-axis direction, as shown in FIG. 3. The connecting tab 20 having such a shape may be referred to as “V-shaped tab”.

Each depression 20a of one blanked member W1 is joined to the corresponding projection 20b of another blanked member W1 that is adjacent to the one blanked member W1 on its upper-surface side. Each projection 20b of the one blanked member W1 is joined to the corresponding depression 20a of still another blanked member W1 that is adjacent to the one blanked member W1 on its lower-surface side.

Each through hole 22 may have a rectangular shape as depicted in FIG. 3. In some examples, the through hole 22 has the shape of an oblong hole extending in the Y-axis direction in FIG. 3. The length A1 of the longer sides (in the Y-axis direction) of the through hole 22 may be approximately 3 millimeters to 5 millimeters, for example. The width B1 of the shorter sides (in the X-axis direction) of the through hole 22 may be approximately 0.5 millimeter to 2 millimeters, for example.

In respective central portions of the pair of longer sides of the through hole 22, notches 28 are formed. The notches 28 are recessed from the central portions of the through hole 22 outward in the X direction in FIG. 3. For example, the through hole 22 formed in a first blanked member may include an area having a length that is greater than a width, and the connecting tab 20 having a chevron shape may be formed in a second blanked member so as to be fitted into the through hole 22 of the first blanked member. On opposite sides of the through hole 22, the notches 28 may be recessed outward from an inner-wall surface of the through hole 22 in opposing directions that correspond to the width of the area of the through hole 22. Each notch 28 may have a rectangular shape. The length A2 of the notch 28 in the longitudinal direction (Y-axis direction in FIG. 3) of the through hole 22 is set shorter than the length A1. The length A2 may be substantially the same as or greater than the length A3 of the tip 24 of the connecting tab 20, or may be set to about ⅓ of the length A1. The width B2 of the notch 28 in the lateral direction (X-axis direction in FIG. 3) of the through hole 22 may be set equal to or greater than a distance that is the sum of a clearance CL between a die hole D2a and a punch P2 (described later in further detail) and 5 micrometers. For example, the width B2 may be equal to or greater than 15 micrometers, or may be approximately 15 micrometers to 20 micrometers.

The corresponding projection 20b of a blanked member W1 adjacent to the blanked member W2 is fitted into each through hole 22. When stacks 10 are successively manufactured, the through hole 22 may be configured to prevent a subsequently formed blanked member W from being fastened by the corresponding connecting tab 20 (projection 20b) to an already manufactured stack 10.

As depicted in FIG. 3, outer surfaces of the shoulders 26 of the connecting tab 20 are brought into contact with partial areas R (areas shaded with dots in FIG. 3) of inner-wall surfaces of the through hole 22, whereby the connecting tab 20 is fitted into the through hole 22. When the connecting tab 20 is fitted into the through hole 22, the tip 24 of the connecting tab 20 passes by the notches 28. Thus, outer surfaces of the tip 24 do not come in contact with the inner-wall surfaces of the through hole 22.

The permanent magnets 12 may be individually inserted into the magnet insertion holes 16 as depicted in FIG. 1 and FIG. 2. Each permanent magnet 12 may be formed in a variety of different shapes, for example, a rectangular parallelepiped shape. The type of the permanent magnet 12 that is selected for the stacked rotor core 1 may be determined according to the applications of the motor, and/or to selectively vary the performance of the motor, and the like. The permanent magnets 12 may include, for example, sintered magnets or bonded magnets.

The solidified resin 14 is produced by charging a resin material in a melted state (melted resin) into the magnet insertion, hole 16 having the permanent magnet 12 and then solidifying the melted resin. The solidified resin 14 may be configured to fix the permanent magnet 12 in the magnet insertion hole 16 and to bond adjacent blanked members W in the height direction. Examples of resin material forming each solidified resin 14 include a thermosetting resin and a thermoplastic resin. Specific examples of the thermosetting resin include resin compositions containing an epoxy resin, a curing initiator, and an additive. Examples of the additive include a filler, a flame retardant, and a stress-lowering agent.

### Manufacturing Device for Stacked Rotor Core

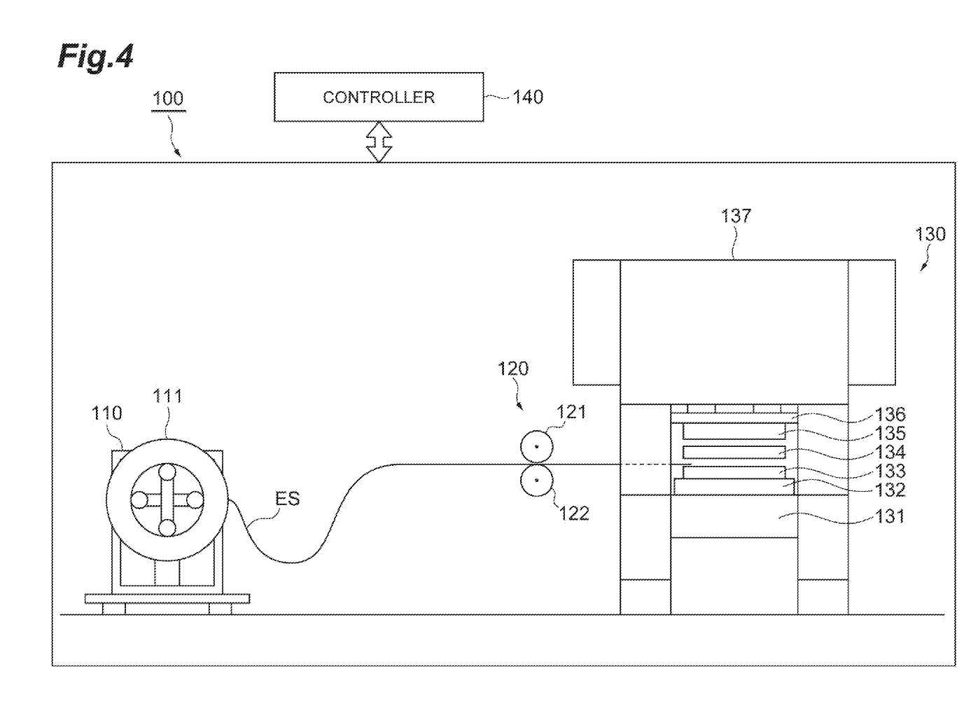

An example manufacturing device 100 for the stacked rotor core 1 is described with reference to FIG. 4 to FIG. 10.

As depicted in FIG. 4, the manufacturing device 100 may be configured to manufacture the stacked rotor core 1 from an electrical steel sheet ES (workpiece sheet) that is a belt-like metal sheet. The manufacturing device 100 includes an uncoiler 110, a feeder 120, a blanking device 130, a magnet mounting device (not depicted), and a controller 140 (control unit).

The uncoiler 110 rotatably supports a coiled material 111 that is a belt-like electrical steel sheet ES wound in a coiled shape, with the coiled material 111 being mounted thereon. The feeder 120 has a pair of rollers 121 and 122 configured to sandwich the electrical steel sheet ES from above and below. The pair of rollers 121 and 122 rotates and stops rotating in response to instruction signals from the controller 140, thereby sequentially feeding the electrical steel sheet ES toward the blanking device 130 on an intermittent basis.

The blanking device 130 operates in response to instruction signals from the controller 140. The blanking device 130 may be configured to sequentially blank, with a plurality of punch units, the electrical steel sheet ES that is fed by the feeder 120 on an intermittent basis to form a blanked member W and to sequentially stack blanked members W obtained by the blanking to produce a stack 10.

The blanking device 130 includes a base 131, a lower die 132, a die plate 133, a stripper 134, an upper die 135, a top plate 136, a press machine 137 (drive unit), and a plurality of punches.

The base 131 is installed on a floor, and supports the lower die 132 placed on the base 131. The lower die 132 holds the die plate 133 placed on the lower die 132. The lower die 132 includes discharge holes at predetermined positions. The discharge holes discharge materials (e.g., blanked members W, waste materials) that have been blanked from the electrical steel sheet ES.

The die plate 133 may be configured to form a blanked member W in conjunction with the punches. The die plate 133 includes dies at positions corresponding to the respective punches. Each die has a die hole into which the corresponding punch can be inserted.

The stripper 134 may be configured to clamp the electrical steel sheet ES between the stripper 134 and the die plate 133 when the electrical steel sheet ES is blanked with the respective punches and to remove the electrical steel sheet ES sticking to the respective punches from the respective punches. The upper die 135 is positioned above the stripper 134. On the upper die 135, base end portions of the respective punches are fixed. Thus, the upper die 135 holds the respective punches.

The top plate 136 is positioned above the upper die 135. The top plate 136 holds the upper die 135. The press machine 137 is positioned above the top plate 136. A piston of the press machine 137 is connected to the top plate 136, and operates in response to instruction signals from the controller 140. When the press machine 137 operates, the piston elongates and contracts, thereby moving all of the stripper 134, the upper die 135, the top plate 136, and the respective punches up and down.

The magnet mounting device operates in response to instruction signals from the controller 140. The magnet mounting device may be configured to insert the permanent magnets 12 into the respective magnet insertion holes 16 of a stack 10 obtained by the blanking device 130 and to charge melted resin into the magnet insertion holes 16 into which the permanent magnets 12 have been inserted.

For example, based on a program stored in a recording medium or based on an operation input from an operator, the controller 140 generates an instruction signal for operating one or more of the feeder 120, the blanking device 130, and the magnet mounting device, and transmits the instruction signal to the corresponding one of the feeder 120, the blanking device 130, and the magnet mounting device.

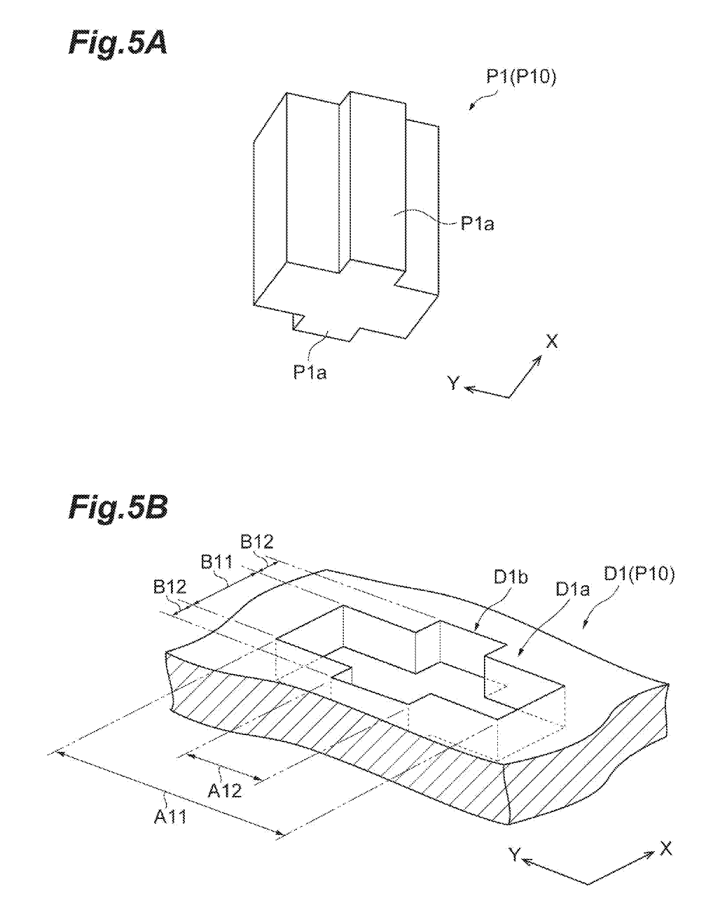

The punches and the dies included in the blanking device 130 are described in more detail with reference to FIG. 5A to FIG. 9. The blanking device 130 includes punch units P10, P20, and P30, for example.

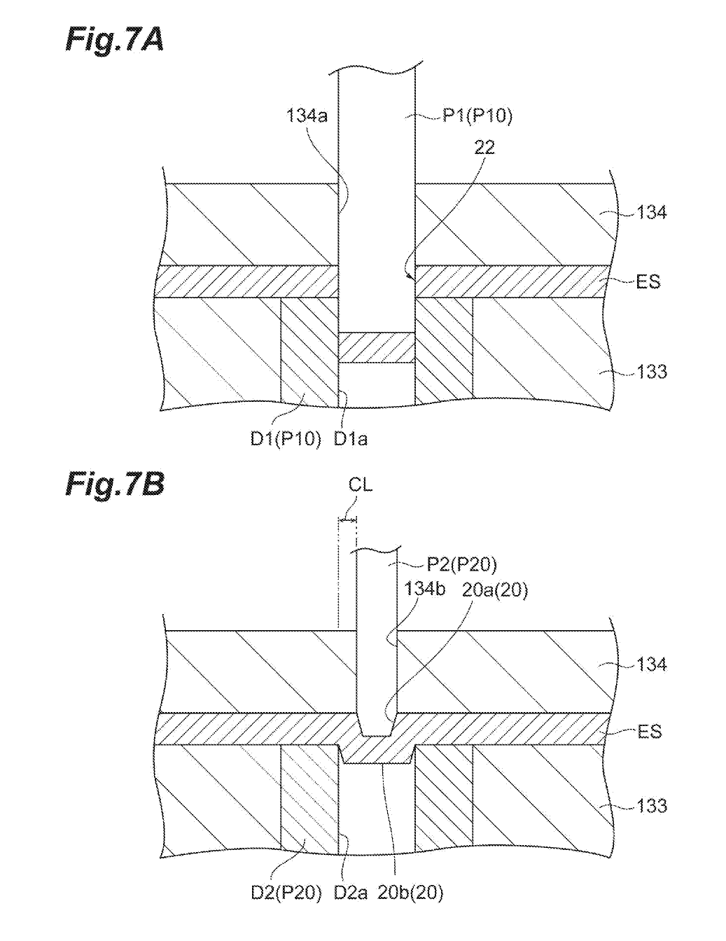

The punch unit P10 (first punch unit) may be configured to form a through hole 22 in the blanked member W2. The punch unit P10 includes a combination of a punch Pi (first punch) and a die D1 (first die) as depicted in FIG. 5A, FIG. 5B and FIG. 7A.

In the die D1, a die hole D1a (first die hole) is formed as depicted in FIG. 5B. The die hole D1a may have a rectangular shape. In some examples, the die hole D1a has the shape of an oblong hole extending in the Y-axis direction in FIG. 5B. The length A11 of the longer sides of the die hole D1a is substantially the same as the length A1 of the longer sides of each through hole 22, and may be approximately 3 millimeters to 5 millimeters, for example. The width B11 of the shorter sides of the die hole D1a is substantially the same as the width B1 of the shorter sides of the through hole 22, and may be approximately 0.5 millimeter to 2 millimeters, for example.

In respective central portions of this pair of longer sides of the die hole D1a, notches D1b are formed. The notches D1b are recessed from the central portions of the die hole D1a outward in the X direction in FIG. 5B. For example, the die hole D1a formed in the die D1 may include an area having a length that is greater than a width. On opposite sides of the die hole D1a, the notches D1b may be recessed outward from an inner-wall surface of the die hole D1a in opposing directions that correspond to the width of the area of the die hole D1a. Each notch D1b may have a rectangular shape. The length A12 of the notch D1b in the longitudinal direction (Y-axis direction in FIG. 5B) of the die hole D1a is substantially the same as the length A2, and is set shorter than the length A11. The length A12 may be set to about ⅓ of the length A11. The width B12 of the notch D1b in the lateral direction (X-axis direction in FIG. 5B) of the die hole D1a may be set equal to or greater than a distance that is the sum of the clearance CL between the die hole D2a and the punch P2 (described later in further detail) and 5 micrometers. The width B12 is substantially the same as the width B2, and may be equal to or greater than 15 micrometers, for example, or may be approximately 15 micrometers to 20 micrometers.

As depicted in FIG. 5A, the punch P1 has a rectangular parallelepiped shape corresponding to the shape of the die hole D1a. The punch P1 has a pair of ridges P1a located on opposite sides of the punch P1. The pair of ridges P1a is positioned in the respective central portions of the opposite sides in the lateral direction of the punch P1. Each ridge P1a has a rectangular parallelepiped shape corresponding to the shape of notch D1b. As depicted in FIG. 7A, the punch P1 is configured to be insertable into and removable from to the die hole D1a through a through hole 134a of the stripper 134.

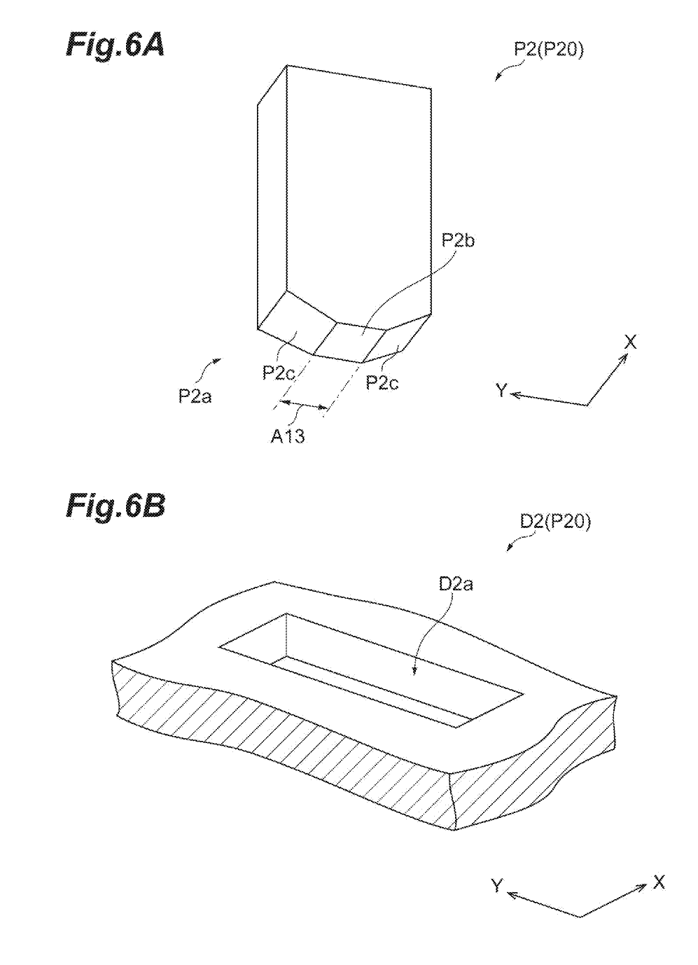

The punch unit P20 (second punch unit) may be configured to form a connecting tab 20 in a blanked member W1. As depicted in FIG. 6A, FIG. 6B and FIG. 7B, the punch unit P20 includes a combination of the punch P2 (second punch) and a die D2 (second die).

As depicted in FIG. 6B, the die hole D2a (second die hole) is formed in the die D2. The die hole D2a has a rectangular shape. The size of the die hole D2a may be substantially the same as the size of the die hole D1a.

As depicted in FIG. 6A, the punch P2 has a rectangular parallelepiped shape corresponding to the shape of the die hole D2a. As depicted in FIG. 7B, the punch P2 is configured to be insertable into and removable from the die hole D2a through a through hole 134b of the stripper 134. As depicted in FIG. 7B, the outer shape of the punch P2 is set slightly smaller than the outer shape of the die hole D2a. The clearance CL between the die hole D2a and the punch P2 can be set to various values depending on fitting force intended to be generated between each connecting tab 20 and the corresponding through hole 22, and may be approximately 10 micrometers to 20 micrometers, or may be approximately 10 micrometers to 15 micrometers, for example. A clearance CL exceeding 20 micrometers may complicate fitting of the projection 20b of the connecting tab 20 into the depression 20a.

A distal-end portion P2a of the punch P2 as a whole has a chevron shape. In some examples, the distal-end portion P2a has a tip P2b where the protruding height is greatest and shoulders P2c that are located on both sides of the tip P2b in the Y-axis direction in FIG. 6A. The tip P2b may have a flat shape. For example, the length A12 of the notch D1b may be substantially the same as or greater than the width A13 of the tip P2b in the Y-axis direction, as illustrated in FIG. 5A. The protruding height of each shoulder P2c gradually decreases from the tip P2b to the outside in the Y-axis direction in FIG. 6A.

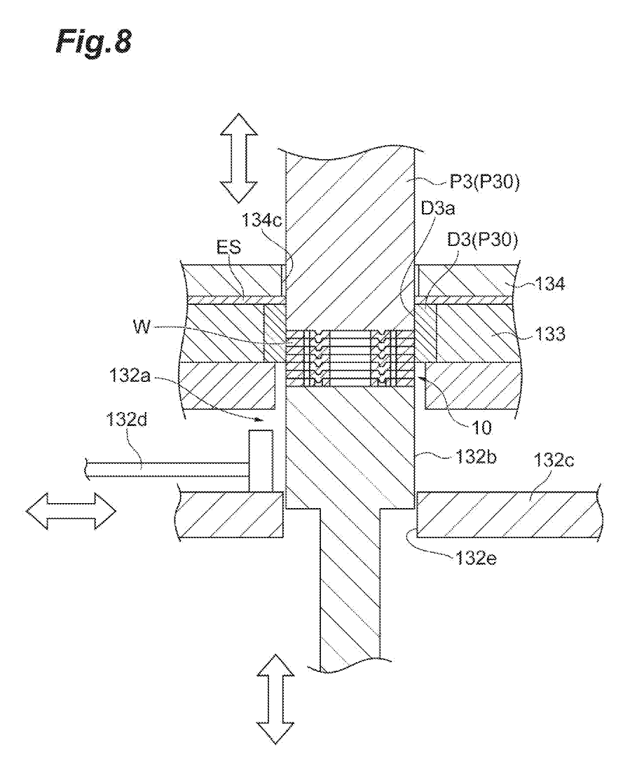

The punch unit P30 (third punch unit) may be configured to blank the electrical steel sheet ES to form a blanked member W. As depicted in FIG. 8, the punch unit P30 includes a combination of a punch P3 (third punch) and a die D3 (third die).

In the die D3, a die hole D3a (third die hole) is formed. The die hole D3a has a shape corresponding to the outer shape of the blanked member W.

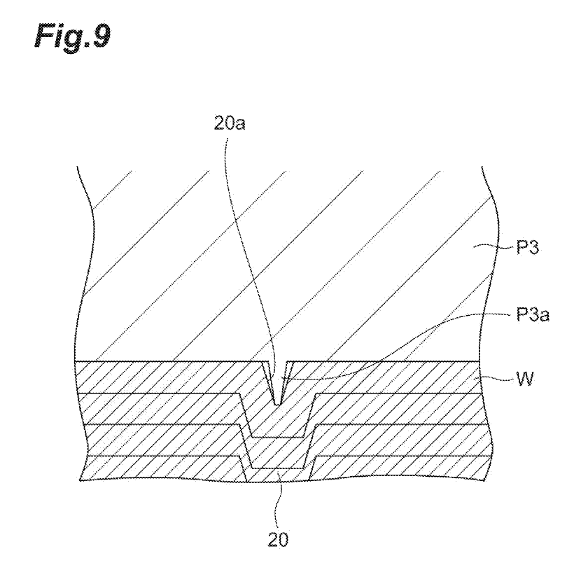

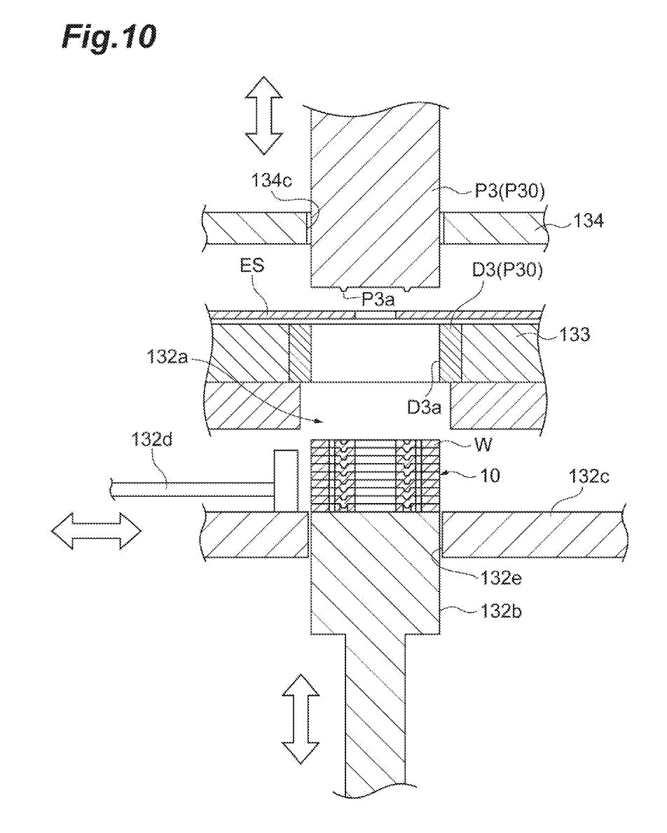

The punch P3 has a shape corresponding to the shape of the die hole D3a. The punch P3 is configured to be insertable into and removable from the die hole D3a through a through hole 134c of the stripper 134. As depicted in FIG. 9 and FIG. 10, on a distal-end surface of the punch P3, a plurality of pressing protrusions P3a are formed. The pressing protrusions P3a protrude from the distal-end surface in a direction intersecting the distal-end surface. The pressing protrusions P3a are each formed at positions corresponding to the connecting tabs 20 formed in the electrical steel sheet ES.

In some examples, a cylinder 132b, a stage 132c, and a pusher 132d are disposed in a space 132a below the die D3. The cylinder 132b is configured to be vertically movable in response to instruction signals from the controller 140. For example, the cylinder 132b moves downward intermittently every time a blanked member W is staked on the cylinder 132b. When a predetermined number of blanked members W have been stacked on the cylinder 132b to form a stack 10, the cylinder 132b moves to a position where a surface of the cylinder 132b is flush with a surface of the stage 132c as depicted in FIG. 10.

In the stage 132c, the cylinder 132b passes through a hole 132e. The pusher 132d is configured to be horizontally movable on the surface of the stage 132c in response to instruction signals from the controller 140. With the surface of the cylinder 132b having moved to a position where the surface of the cylinder 132b is flush with the surface of the stage 132c, the pusher 132d pushes out the stack 10 from the cylinder 132b to the stage 132c. The stack 10 pushed out to the stage 132c may be conveyed to a subsequent step by a conveyor, for example.

### Method for Manufacturing Stacked Rotor Core

An example method for manufacturing a stacked rotor core 1 is described with reference to FIG. 4 and FIG. 7A to FIG. 10.

As depicted in FIG. 4, the electrical steel sheet ES is fed by the feeder 120 to the blanking device 130, and when a portion of the electrical steel sheet ES to be processed has reached a predetermined punch, the method may include the formation of a through hole corresponding to the shaft hole 10a (e.g., stamping at the inner circumference), and the formation of through holes corresponding to the respective magnet insertion holes 16. Additionally, the method may include the formation of the connecting tabs 20 or through holes 22, and blanking of a blanked member W from the electrical steel sheet ES (e.g., stamping at the outer circumference).

The connecting tabs 20 and the through holes 22 are selectively formed. For example, in an area of the electrical steel sheet ES where a blanked member W1 is to be formed, the connecting tabs 20 are formed, and in an area of the electrical steel sheet ES where a blanked member W2 is to be formed, the through holes 22 are formed.

An example formation of the through hole 22 is described with reference to FIG. 7A. When the blanking device 130 operates in response to instruction signals from the controller 140, the stripper 134 moves down toward the die plate 133, and the electrical steel sheet ES is clamped by the die plate 133 and the stripper 134. In this state, when the blanking device 130 further operates, the punch P1 moves down through the through hole 134a of the stripper 134, and the distal-end portion of the punch P1 extrudes the electrical steel sheet ES into the die hole D1a of the die D1 held by the die plate 133. Thus, the through hole 22 is formed in the electrical steel sheet ES by the punch P1.

An example formation of the connecting tab 20 is described with reference to FIG. 7B. When the blanking device 130 operates in response to instruction signals from the controller 140, the stripper 134 moves down toward the die plate 133, and the electrical steel sheet ES is clamped by the die plate 133 and the stripper 134. In this state, when the blanking device 130 further operates, the punch P2 moves down through the through hole 134b of the stripper 134, and the distal-end portion of the punch P2 extrudes the electrical steel sheet ES into the die hole D2a of the die D2 held by the die plate 133. Thus, the connecting tab 20 is formed in the electrical steel sheet ES by the punch P2.

An example blanking operation of the blanked member W from the electrical steel sheet ES is described with reference to FIG. 8 to FIG. 11. When the blanking device 130 operates in response to instruction signals from the controller 140, the stripper 134 moves down toward the die plate 133, and the electrical steel sheet ES is clamped by the die plate 133 and the stripper 134. In this state, when the blanking device 130 further operates, the punch P3 moves down through the through hole 134c of the stripper 134, and the distal-end portion of the punch P3 is inserted into the die hole D3a of the die D3 held by the die plate 133. Thus, the blanked member W is blanked from the electrical steel sheet ES by the punch P3.

When a blanked member W2 is blanked from the electrical steel sheet ES by the punch P3, the pressing protrusions P3a are inserted into the through holes 22, and the electrical steel sheet ES is not processed. In contrast, when a blanked member W1 is blanked from the electrical steel sheet ES by the punch P3, each pressing protrusion P3a presses the depression 20a of the corresponding connecting tab 20 (see FIG. 9). Thus, the projection 20b of the connecting tab 20 is press-fitted into the depression 20a of a connecting tab 20 or the through hole 22, whereby both of them are fitted together.

Blanked members W blanked from the electrical steel sheet ES by the punch P3 are stacked on the cylinder 132b, whereby a stack 10 is formed as depicted in FIG. 8. As depicted in FIG. 10, the stack 10 is pushed out by the pusher 132d from the cylinder 131b to the stage 132c. Subsequently, the magnet mounting device charges permanent magnets 12 and melted resin into the magnet insertion holes 16 of the stack 10, and the permanent magnets 12 are fixed in the magnet insertion holes 16 by the solidified resins 14. Thus, a stacked rotor core 1 is completed.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

For example, the notches D1b formed in the die hole D1a may have a shape (e.g., triangular shape, trapezoidal shape, semispherical shape, or arched shape) other than the rectangular shape.

A group of magnets including two or more permanent magnets 12 in combination may be inserted into one magnet insertion hole 16. For example, a plurality of permanent magnets 12 may be arranged in the longitudinal direction of one magnet insertion hole 16. Additionally, a plurality of permanent magnets 12 may be arranged in the height direction of the one magnet insertion hole 16. Still further, a first set of permanent magnets 12 may be arranged in the longitudinal direction of the one magnet insertion hole 16 and a second set of permanent magnets 12 may be arranged in the height direction.

One or more of the methods, procedures, steps or operations described here may be applied not only to the stacked rotor core 1 but also a stacked stator core. In some examples, the stacked stator core may be a segmented stacked stator core formed with a plurality of core pieces in combination, or may be an unsegmented stacked stator core.

### Additional Examples

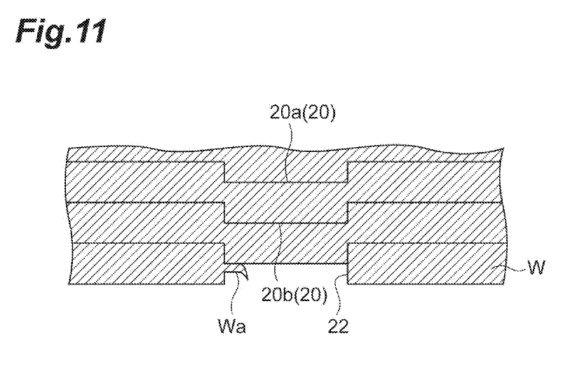

If the notches 28 are not formed in the through hole 22, as depicted in FIG. 11, when the projection 20b of a connecting tab 20 is fitted into the through hole 22, the projection 20b may rub on an inner-wall surface of the through hole 22, thereby causing a burr Wa to be formed inside the through hole 22. When a motor is configured with a stacked rotor core 1 including a blanked member W having such a burr Wa, vibrations and centrifugal force, for example, are applied to the burr Wa when the motor operates, which may cause the burr Wa to fall off. Consequently, the, burr Wa may hit components of the motor, whereby an unusual noise may be generated from the motor, and performance of the motor may be adversely affected. As the development of hybrid vehicles and electric vehicles has progressed, the number of vehicles having a motor as a drive source is rapidly increasing. Thus, there is an increasing demand for vehicle-mounted motors having a higher level of safety.

An example stacked core (1) may include a stack (10) formed by stacking a plurality of blanked members (W). The plurality of blanked members (W) include a first blanked member (W2) forming an outermost layer of the stack (10) in a height direction and a second blanked member (W1) adjacent to the first blanked member (W2). A through hole (22) having the shape of an oblong hole is formed in the first blanked member (W2). Additionally, a connecting tab (20) having a chevron shape formed so as to be fitted into the through hole (22) and protruding toward the through hole (22) is formed in the second blanked member (W1). Notches (28) that are recessed outward in an opposing direction of a pair of longer sides of the through hole (22) are formed in respective central portions of the longer sides of the through hole (22). For example, the through hole (22) formed in a first blanked member may include a through hole area having a length that is greater than a width, and the connecting tab (20) having a chevron shape may be formed in a second blanked member so as to be fitted into the through hole (22) of the first blanked member. On opposite sides of the through hole (22), the notches (28) may be recessed outward from an inner-wall surface of the through hole (22) in opposing directions that correspond to the width of the through hole area. When this V-shaped tab (20) is press-fitted into the through hole (22), a vicinity of a tip (24) of the connecting tab (20) passes by the notches (28), and is accordingly less likely to come into contact with the inner-wall surfaces of the through hole (22). Thus, the protrusion of the connecting tab (20) becomes less likely to substantially rub against the inner-wall surfaces of the through hole (22), whereby the formation of burrs can be reliably prevented. Additionally, when V-shaped tab (20) is press-fitted into the through hole (22), the shoulders (26) and vicinity of a projection (20b) of the connecting tab (20) come into contact with the inner-wall surfaces of the through hole (22). This causes the connecting tab (20) and the through hole (22) to be fitted together. Accordingly, the connecting tab (20) and the through hole (22) can be fitted together, and also the formation of burrs can be prevented in a very simple manner with the notches (28).

In some examples, the tip (24) of the connecting tab (20) may have a flat shape, and the length (A2) of each notch (28) in a longitudinal direction of the through hole (22) may be equal to or greater than the width (A3) of the tip (24) of the connecting tab (20) in a direction corresponding to the longitudinal direction. In this case, a vicinity of the tip (24) of the connecting tab (20) is still less likely to come in contact with the inner-wall surfaces of the through hole (22). Thus, the formation of burrs can be more reliably prevented.

In some examples, the width (B2) of each notch (28) in the opposing direction may be equal to or greater than 15 micrometers. Additionally, the clearance (CL) between a die hole (D2a) and a punch (P2) that are used for forming the connecting tab (20) may be set equal to or greater than 10 micrometers. In some examples, the width (B2) of the notch 28 is set to a distance exceeding the clearance (CL). Thus, even if a vicinity of the tip (24) of the connecting tab (20) is pushed out into the notches (28) when the connecting tab (20) is press-fitted into the through hole (22), this vicinity is less likely to come into contact with the inner-wall surfaces of the notches (28). Thus, the formation of burrs can be more reliably prevented.

In some examples, each notch (28) may have a rectangular shape when viewed from the height direction e.g., when viewed from above). A punch (P1) having a shape corresponding to contours of the through hole (22) and the notch (28) can be easily formed.

An example device (100) for manufacturing a stacked core may include a first punch unit (P10) configured to form a through hole (22) in a belt-like metal sheet (ES), a second punch unit (P20) configured to form a connecting tab (20) in the metal sheet (ES), and a third punch unit (P30) configured to blank the metal sheet (ES) to form a blanked member (W). Additionally, the example device (100) may include a drive unit (137) configured to drive the first to third punch units (P10 to P30), and a control unit (140). The first punch unit (P10) includes a first die (D1) in which a first die hole (D1a) having the shape of an oblong hole is formed. Additionally, the first punch unit (P10) may include a first punch (P1) having a shape corresponding to the shape of the first die hole (D1a) and configured to be insertable into and removable from the first die hole (D1a). In some examples, notches (D1b) recessed outward in an opposing direction of a pair of longer sides are formed in respective central portions of the longer sides of the first die hole (D1a). The second punch unit (P20) includes a second die (D2) in which a second die hole (D2a) having the shape of an oblong hole is formed. Additionally, the second punch unit (P20) may include a second punch (P2) having a shape corresponding to the shape of the second die hole (D2a) and configured to be insertable into and removable from the second die hole (D2a). The second punch (P2) has a chevron shape tapering toward its distal end. The third punch unit (P30) includes a third die (D3) in which a third die hole (D3a) having a shape corresponding to the outer shape of the blanked member (W) is formed. Additionally, the third punch unit (P30) may include a third punch (P3) having a shape corresponding to the shape of the third die hole (D3a) and configured to be insertable into and removable from the third die hole (D3a). The control unit (140) is configured to control the first punch unit (P10) to form the through hole (22) in the metal sheet (ES), and to control the third punch unit (P30) to blank a first blanked member (W2) having the through hole (22) from the metal sheet (ES). Additionally, the control unit (140) may be configured to control the second punch unit (P20) to form the connecting tab (20) in the metal sheet (ES), and to control the third punch unit (P30) to blank a second blanked member (W1) having the connecting tab (20) from the metal sheet (ES) and also to fit the connecting tab (20) into the through hole (22), thereby stacking the first and second blanked members (W2, W1).

In some examples, a tip (P2b) of the second punch (P2) has a flat shape, and the length (A12) of each notch (D1b) in a longitudinal direction of the first die (D1) may be equal to or greater than the width (A13) of the tip (P2b) of the second punch (P2) in a direction corresponding to the longitudinal direction.

In some examples, the width (B12) of each notch (D1b) in the opposing direction may be equal to or greater than the sum of a clearance (CL) between the second die hole (D2a) and the second punch (P2) and 5 micrometers.

In some examples, each notch (D1b) may have a rectangular shape when viewed from an insertion direction of the first punch (P1) into the first die hole (D1a).

An example method for manufacturing a stacked core (1) may include forming a through hole (22) in a belt-like metal sheet (ES) by inserting, into a first die hole (D1a) having the shape of an oblong hole, a first punch (P1) having a shape corresponding to the shape of the first die hole (D1a). Additionally, the example method may include forming a connecting tab (20) in the metal sheet (ES) by inserting, into a second die hole (D2a) having the shape of an oblong hole, a second punch (P2) having a shape corresponding to the shape of the second die hole (D2a) and having a chevron shape tapering toward its distal end. A first blanked member (W2) having the through hole (22) may be blanked from the metal sheet (ES) by inserting, into a third die hole (D3a) having a predetermined shape, a third punch (P3) having a shape corresponding to the shape of the third die hole (D3a). Additionally, by inserting the third punch (P3) into the third die hole (D3a), a second blanked member (W1) having the connecting tab (20) may be blanked from the metal sheet (ES) and the connecting tab (20) may be fitted into the through hole (22) to stack the first and second blanked members (W2, W1). In some examples, notches (D1b) recessed outward in an opposing direction of the pair of long sides are formed in respective central portions of a pair of the long sides of the first die hole (D1a).

In some examples, a tip (24) of the second punch (P2) may have a flat shape, and the length (A12) of each notch (D1b) in a longitudinal direction of the first die (D1) may be equal to or greater than the width (A13) of the tip (P2b) of the second punch (P2) in a direction corresponding to the longitudinal direction.

In some examples, the width (B12) of each notch (D1b) in the opposing direction may be equal to or greater than the sum of a clearance (CL) between the second die hole (D2a) and the second punch (P2) and 5 micrometers.

In some examples, each notch (D1b) may have a rectangular shape when viewed from an insertion direction of the first punch (P1) into the first die hole (D1a).

We claim all modifications and variations coming within the spirit and scope of the subject matter claimed herein.

1. A stacked core comprising:
a stack formed by stacking a plurality of blanked members,
wherein the plurality of blanked members includes a first blanked member forming an outermost layer of the stack and a second blanked member located adjacent to the first blanked member,
wherein a through hole formed in the first blanked member, an area of the through hole having a length that is greater than a width,
wherein a connecting tab having a chevron shape formed in the second blanked member so as to be fitted into the through hole of the first blanked member, and
wherein on opposite sides of the through hole, notches are recessed outward from an inner-wall surface of the through hole in opposing directions that correspond to the width of the area of the through hole.

2. The stacked core according to claim 1,
wherein a tip of the connecting tab has a flat shape, and
wherein the length of each notch in a longitudinal direction corresponding to the length of the area of the through hole is equal to or greater than the width of the tip of the connecting tab in a direction corresponding to the longitudinal direction.

3. The stacked core according to claim 1, wherein the width of each notch in the opposing directions is equal to or greater than approximately 15 micrometers.

4. The stacked core according to claim 1, wherein each notch has a rectangular shape when viewed from above the through hole.

5. A device for manufacturing a stacked core comprising:
a first punch unit configured to form a through hole in a metal sheet;
a second punch unit configured to form a connecting tab in the metal sheet;
a third punch unit configured to blank the metal sheet to form a blanked member;
a drive unit configured to drive the first to third punch units; and
a control unit,
wherein the first punch unit includes:
a first die in which a first die hole is formed, an area of the first die hole having a length that is greater than a width; and
a first punch having a shape corresponding to the shape of the first die hole and configured to be insertable into and removable from the first die hole,
wherein, on opposite sides of the first die hole, notches are recessed outward from an inner-wall surface of the first die hole in opposing directions that correspond to the width of the area of the first die hole,
wherein the second punch unit includes:
a second die in which a second die hole is formed, an area of the second die hole having a length that is greater than a width; and
a second punch having a shape corresponding to the shape of the second die hole and configured to be insertable into and removable from the second die hole,
wherein the second punch has a chevron shape tapering toward its distal end,
wherein the third punch unit includes:
a third die in which a third die hole having a shape corresponding to an outer shape of the blanked member is formed; and
a third punch having a shape corresponding to the shape of the third die hole and configured to be insertable into and removable from the third die hole, and
wherein the control unit is configured to
control the first punch unit to form the through hole in the metal sheet,
control the third punch unit to blank: a first blanked member having the through hole from the metal sheet,
control the second punch unit to form the connecting tab in the metal sheet, and
control the third punch unit to blank a second blanked member having the connecting tab from the metal sheet and also to fit the connecting tab into the through hole, thereby
stacking the First and second blanked members.

6. The device according to claim 5,
wherein a tip of the second punch has a flat shape, and
wherein a length of each notch in a longitudinal direction of the first die is equal to or greater than a width of the tip of the second punch in a direction corresponding to the longitudinal direction

7. The device according to claim 5, wherein a width of each notch in the opposing directions is equal to or greater than a sum of a clearance between the second die hole and the second punch and approximately 5 micrometers.

8. The device according to claim 5, wherein each notch has a rectangular shape when viewed from an insertion direction of the first punch into the first die hole.

9. A method of manufacturing a stacked core comprising:
forming a through hole in a metal sheet by inserting, into a first die hole, a first punch having a shape corresponding to the first die hole, an area of the first die hole having a length that is greater than a width;
forming a connecting tab in the metal sheet by inserting, into a second die hole, a second punch having a shape corresponding to the shape of the second die hole and having a chevron shape tapering toward its distal end, an area of the second die hole having a length that is greater than a width;
blanking a first blanked member having the through hole from the metal sheet by inserting, into a third die hole having a predetermined shape, a third punch having a shape corresponding to the shape of the third die hole; and
blanking a second blanked member having the connecting tab from the metal sheet and also fitting the connecting tab into the third die hole by inserting the third punch into the through hole to stack the first and second blanked members,
wherein, on opposite sides of the first die hole, notches are recessed outward from an inner-wall surface of the first die hole in opposing directions that correspond to the width of the first die hole.

10. The method according to claim 9,
wherein a tip of the second punch has a fiat shape, and
wherein a length of each notch in a longitudinal direction of the first die hole is equal to or greater than a width of the tip of the second punch in a direction corresponding to the longitudinal direction.

11. The method according to claim 9, wherein a width of each notch in the opposing directions is equal to or greater than a sum of a clearance between the second die hole and the second punch and approximately 5 micrometers.

12. The method according to claim 9, wherein each notch has a rectangular shape when viewed from an insertion direction of the first punch into the first die hole.

13. the method according to claim 9, wherein the area of the first die hole has a rectangular shape.

14. The method according to claim 13, wherein the area of the second die hole has a rectangular shape.
